(19) United States
(12) Patent Application Publication
(10) Pub. No.: US 2026/0080313 A1
(43) Pub. Date: Mar. 19, 2026

(54) DOMAIN-AWARE NEUROSYMBOLIC AGENTS FOR IMPROVING PROBLEM-SOLVING ACCURACY AND CONSISTENCY

(71) Applicant: Aitomatic, Inc., Cupertino, CA (US)

(72) Inventors: Christopher Nguyen, Los Altos, CA (US); The-Vinh Luong, San Jose, CA (US); Xuan-Sang Dinh, Ho Chi Minh City (VN); Zooey Nhu-Quynh Nguyen, Los Altos, CA (US); Shruti Raghavan, San Jose, CA (US); Manh Nguyen Nguyen, Palo Alto, CA (US); Quynh Thi-Tham Le, San Jose, CA (US); Hung Phi Vo, Ho Chi Minh City (VN); Tan-Loc Nguyen, Ho Chi Minh City (VN); Anh Hai Ha, Sunnyvale, CA (US); Phuong-Thao Nguyen, Ho Chi Minh City (VN)

(21) Appl. No.: 19/331,378

(22) Filed: Sep. 17, 2025

Related U.S. Application Data
(60) Provisional application No. 63/696,337, filed on Sep. 18, 2024.

(51) Int. Cl. G06N 20/00; G06F 16/242; G06N 3/0475; G06N 5/022

(52) U.S. Cl. CPC G06N 20/00; G06F 16/243; G06N 3/0475; G06N 5/022

(57) ABSTRACT

A system receives domain specific questions from users and answers them. The system stores domain specific information comprising domain specific facts and domain specific programs. The system receives an input request to perform a domain specific task for the particular domain. The system provides the input request to a machine learning model trained to predict a score indicating whether the input request should be processed by a symbolic processor or by a neural network. If the score predicted by the machine learning model indicates that the input request should be processed by the symbolic processor, the system determines whether a stored domain specific program can solve the input request. If none of the stored domain specific programs can solve the input request, the system generates a new program for solving the input request using a machine learning based language model and the set of domain specific facts.

### CROSS REFERENCE TO RELATED APPLICATION

This application claims the benefit under 35 U.S.C. § 119(e) of U.S. Provisional Patent Application Ser. No. 63/696,337, filed on Sep. 18, 2024, which is incorporated by reference in its entirety.

### FIELD OF INVENTION

The disclosure relates in general to artificial intelligence and machine learning techniques combining neural-network processing with symbolic processing, and the organization of domain-specific knowledge involved in such processing.

### BACKGROUND

Machine learning based language models, for example, Large Language Models (LLMs) have shown remarkable capabilities for processing unstructured inputs, for example, natural language-based questions. Such machine learning based models can have very large number of parameters, for example, several billions of parameters. Such models have an inherent probabilistic nature that often leads to inconsistency and inaccuracy in complex problem-solving tasks. For several domains, for example, industrial tasks such as processing and manufacturing in semiconductor industry, it is important to have predictable execution and results. Having a non-deterministic component during the processing or execution in such domains makes the results less predictable, resulting in less control over the quality of products. As a result, such processes may not be able to provide the guarantees and preciseness needed. This makes it challenging to use such non-deterministic machine learning based language models for several types of tasks.

### SUMMARY

A system receives domain specific questions from users and answers them, for example, domain specific questions associated with semiconductor processing. The system stores domain specific information obtained from one or more users, for example from domain experts. The domain specific information comprises (1) a set of domain specific facts and (2) a set of domain specific programs. The system receives an input request to perform a domain specific task for the particular domain. The system provides the input request to a machine learning model trained to predict a score indicating whether the input request should be processed by a symbolic processor or by a neural network. The symbolic processor generates deterministic output and the neural network generates a non-deterministic output. The system executes the machine learning model to predict a score indicating whether the input request should be processed by a symbolic processor or by a neural network. Responsive to the score predicted by the machine learning model indicating that the input request should be processed by the symbolic processor, the system determines whether a domain specific program from the set of domain specific programs is configured to solve the input request. Responsive to determining that none of the set of domain specific programs are configured to solve the input request, the system generates a new program for solving the input request using a machine learning based language model and the set of domain specific facts.

Embodiments perform steps of the methods disclosed hereon. Embodiments include computer readable storage media storing instructions for performing the steps of the above method. Embodiments include computer systems that comprise one or more computer processors and a computer readable storage medium store instructions for performing the steps of the above method.

The features and advantages described in this summary and the following detailed description are not all-inclusive. Many additional features and advantages will be apparent to one of ordinary skill in the art in view of the drawings, specification, and claims hereof.

### FIGURES

FIG. 1 shows system architecture of a domain-aware neurosymbolic agent based system, according to an embodiment.

FIG. 2A illustrates manual and automated capture performed by knowledge apply knowledge apply module 125, according to an embodiment.

FIG. 2B illustrates information extracted via manual and automated capture performed by knowledge apply module 125, according to an embodiment.

FIG. 3 illustrates various components of the DANA architecture and their interactions, according to an embodiment.

FIG. 4 illustrates various components of the DANA architecture and their interactions, according to an embodiment.

FIG. 5 illustrates various components of the DANA architecture and their interactions, according to an embodiment.

FIG. 6 illustrates various components of the DANA architecture and their interactions, according to an embodiment.

FIG. 7 illustrates various components of the DANA architecture and their interactions, according to an embodiment.

FIG. 8 illustrates various components of the DANA architecture and their interactions, according to an embodiment.

FIG. 9 is a high-level block diagram illustrating an example system, in accordance with an embodiment.

### DETAILED DESCRIPTION

A system referred to as DANA (Domain-Aware Neurosymbolic Agent) system implements an architecture that integrates domain-specific knowledge with neurosymbolic processing. The DANA system incorporates domain expertise in both natural-language and symbolic forms, enabling more deterministic and reliable problem-solving. An implementation of DANA system was tested to achieve over 90% accuracy on a benchmark, significantly outperforming current LLM-based systems in both consistency and accuracy. The DANA system implements neurosymbolic artificial intelligence by leveraging domain specific knowledge to mitigate the probabilistic limitations of LLMs. The DANA system is designed to tackle complex, real-world problems that require precision and reliability, for solving practical applications in AI system design where consistency and accuracy are significant.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

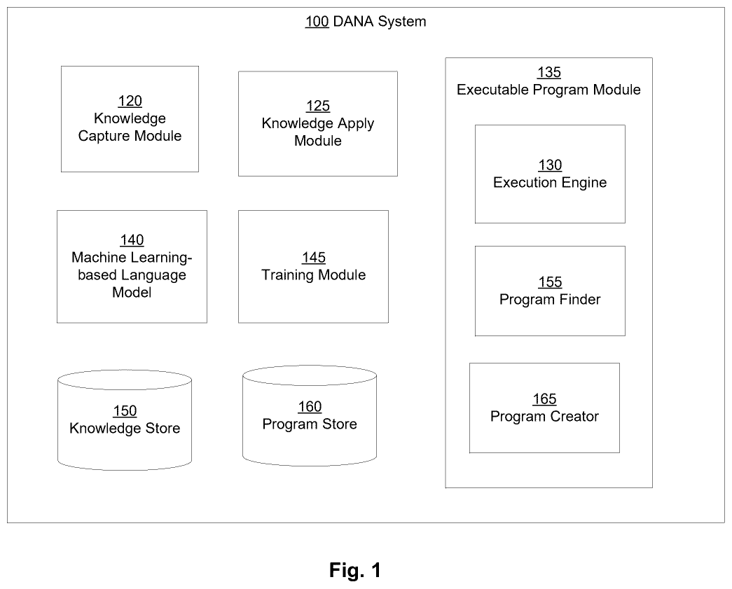

FIG. 1 shows system architecture of a domain-aware neurosymbolic agent (DANA) based system, according to an embodiment. The DANA system comprises a knowledge capture module 120, a knowledge apply module 125, a executable program module 135, a machine learning based language model 140, a training module 145, a knowledge store 150, and a program store 160. The DANA system 100 may also be referred to herein as a system or an online system.

The knowledge capture module 120 allows the system to retain important domain-specific expertise to help achieve consistent and accurate problem-solving. The knowledge apply module 120 allows the system to perform program search and execution to solve problems. The execution engine 130 of the executable program module 135 performs the program execution to achieve consistency and accuracy.

An example implementation of DANA system 100 includes (1) Knowledge Store 150: a text storage containing domain-specific definitions, facts, formulas, expert heuristics and rules of thumb, all described in natural language. The program format may be Hierarchical Task Plans (HTPs) with natural-language task descriptions, which provide a human-understandable means for expressing how a goal can be achieved or a problem solved through hierarchical decomposition. (2) Program Store 160: a structured storage containing HTPs, each with a unique name and descriptive metadata about the problem it is designed to solve. (3) Program Finder 155: implemented with an LLM for recognizing directly applicable programs for posed problems through descriptive metadata in the Program Store. (4) Program Creator 165: implemented with an LLM that can be instructed to decompose a target problem or task into a more detailed HTP with sub-tasks. (5) execution engine 130 comprising program execution mechanism that utilizes Observe-Orient-Decide-Act reasoning (OODAR) for executing HTPs.

The DANA system 100 achieves greater deterministic behavior compared to conventional LLMs and provides more consistent and accurate output in autonomous problem-solving. The DANA system 100 implements a first-class treatment of domain-specific knowledge and uses both natural-language and symbolic representations of knowledge. The knowledge representation in DANA system 100 is divided into at least two categories: facts-and-rules knowledge and programs.

The DANA system 100 collects domain specific knowledge and stores in knowledge store 150. The DANA system 100 collects, for example, knowledge specific to a domain such as manufacturing of specific machinery or equipment, semiconductor industry, security, health sciences, and so on. The DANA system 100 stores knowledge in symbolic representation wherever possible. If the DANA system 100 is unable to generate a symbolic representation of the knowledge, the DANA system 100 stores the knowledge in an unstructured form.

The DANA system 100 models knowledge-capture (CAPTURE) and knowledge-application (APPLY) processes. The knowledge capture module 120 implements a knowledge-capture process that involves the reception, extraction, and translation of knowledge, typically in natural-language form.

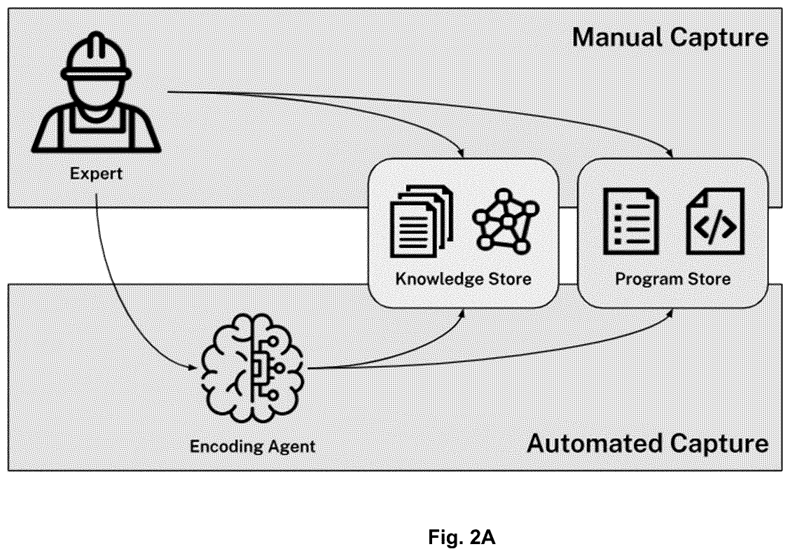

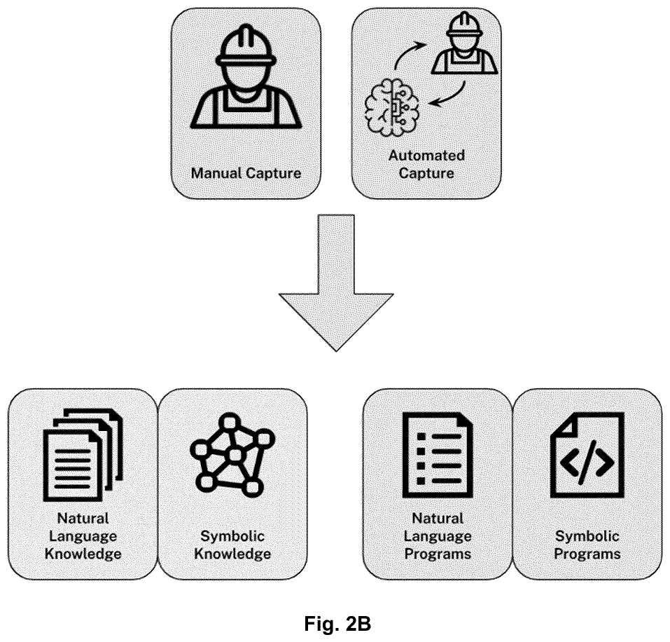

The knowledge capture module 120 implements methods for populating the knowledge store 150 and the program store 160, including both manual and automated approaches. FIG. 2A illustrates manual and automated capture performed by knowledge apply module 125, according to an embodiment. The knowledge capture module 120 may implement (1) Manual Capture: domain experts or AI engineers directly input facts-and-rules knowledge and programs; and (2) Automated Capture (AC): a Knowledge Encoding Assistant interviews domain experts and automatically encodes their knowledge and problem-solving strategies.

FIG. 2B illustrates information extracted via manual and automated capture performed by knowledge apply module 125, according to an embodiment. The knowledge capture module 120, determines whether information received from an expert is (a) fact, (b) rule or (c) program and stores accordingly. The knowledge capture module 120 may represent a fact as a triple comprising (i) an entity, (ii) a property of the entity, and (iii) a value of the property. The knowledge capture module 120 may represent a rule as a conditional inference rule that has a condition and one or more other facts that are likely to be true if the condition evaluates to true. The rules may represent domain specific knowledge captured from experts. Accordingly, a rule indicates that if a condition is true, certain fact F has a high likelihood of being true, and if the condition evaluates to false, the fact F has a high likelihood of being false. As an example, in an industrial context, a rule may specify (1) a condition that checks whether the temperature exceeds a threshold value and (2) one or more facts that are likely to be true if the temperature exceeds the threshold value, such as particular equipment being broken. The additional facts help the system with inference since the system has additional facts to arrive at specific conclusions and perform specific tasks/processes. A rule may be represented using natural language or as relations based on a specific syntax. A program is a step-by-step, hierarchical, or another symbolic representation of analyses or actions to perform to solve a problem

The knowledge capture module 120 may extract knowledge from domain experts. According to an embodiment, the knowledge capture module 120 generates questions specific to the domain and presents the questions to an expert via a user interface or as messages. The knowledge capture module 120 receives the answers to the questions and stores them. The knowledge capture module 120 may generate domain specific questions by using machine learning based language model 140. For example, the knowledge capture module 120 generates prompt requesting the machine learning based language model 140 to generate domain specific questions and executes the machine learning based language model 140 using the prompt. The knowledge capture module 120 extracts the questions from the response obtained by executing the machine learning based language model 140. According to an embodiment, the knowledge capture module 120 performs internet searches to extract domain specific documents. The knowledge capture module 120 uploads one or more documents to the machine learning based language model 140 and requests the machine learning based language model 140 to generate domain specific questions for asking experts based on information stored in the documents. According to an embodiment, the knowledge capture module 120 transforms information received from experts into actionable processes or programs. For example, the knowledge capture module 120 provides information obtained from an expert to the machine learning based language model 140 and request the machine learning based language model 140 to generate a program representing a set of instructions to perform a task based on the knowledge obtained from the expert. The program may be specified in a programming language such as Python or may be a set of natural language instructions.

The knowledge apply module 125 applies the knowledge captures by the knowledge capture module 120. The knowledge capture module 120 stores knowledge in a representation suitable for later application by the knowledge apply module 125, e.g., in program search and program execution for problem-solving. According to an embodiment, the knowledge capture module 120 determines whether to match each stored program with a given context and what fact and rule to utilize for executing a program. According to an embodiment, the knowledge apply component performs program search and program execution. The program search step comprises finalizing the program to execute for solving the problem at hand, for example, by attempting to find an appropriate program that was previously stored or creating a new program if none of the stored programs are applicable. The program execution step involves retrieving and utilizing relevant captured facts and rules to run a chosen program for problem-solving.

The knowledge store 150 stores domain specific information representing a collection of definitions, facts, formulas, expert heuristics and inference rules useful in the concerned domain. This knowledge can be referred to and leveraged in both program search and program execution, providing a store of domain-specific information that enhances DANA's consistency and accuracy. The facts-and-rules knowledge in knowledge store 150 can take two forms: (1) natural-language knowledge (NK): knowledge represented in natural language, easily understandable by humans; and (2) symbolic knowledge (SK): knowledge represented in more formal, symbolic forms (e.g., Prolog relations). Accordingly, the DANA system 100 stores knowledge using various representations and processes it as appropriate for solving domain specific problems. During problem-solving, the DANA system 100 processes natural-language knowledge using machine learning based language model 140 or neural networks (e.g., LLMs) for interpretation and reasoning, while the DANA system 100 processes symbolic knowledge using symbolic engines with deterministic operations. For example, programs specified using specific programming languages may be processed using the compiler or interpreter for the corresponding programming language.

The program store 160 stores programs determined to be applicable to certain well-characterized problems in a particular domain. For each program, the program store 160 stores a descriptive metadata about its purpose. This metadata facilitates program search performed by the DANA system 100 during the problem-solving process. This component allows DANA system 100 to quickly identify and apply known solutions to familiar problem types. The programs stored in program store 160 may take following forms: (1) natural-language Programs (NP): programs described largely in natural language, e.g., hierarchical task plans (HTPs) with natural-language tasks; and (2) symbolic programs (SP): programs in symbolic forms, such as Python code, Java code, R programming language, and so on. Other examples of symbolic knowledge included structured information such as mathematical equations or specific set of instructions for performing operations. Representations of structured information may be in form or data structures or documents using formats such as XML (extensible markup language) format. Representations of structured information may use natural language. Other types of components that perform symbolic processing include systems such as MATLAB or Mathematica for mathematical processing, logic theorem prover systems, rule based expert systems, and so on. The symbolic representation of data is used by the DANA system 100 to perform deterministic processing. The natural language representations of knowledge and programs are processed using machine learning based language model 140 and lead to non-deterministic processing. Furthermore, the system first attempts to perform any domain specific task using symbolic knowledge and programs so as to allow deterministic execution of the task. If symbolic knowledge or programs are not available, the DANA system 100 uses natural language based knowledge and programs to perform the task. The system increases the amount of symbolic knowledge and programs stored over time to allow more and more deterministic processing.

The executable program module 135 implements a program search process using a program finder module 155 and a program creator module 165. The executable program module 135 further includes an execution engine 130. The program finder module 155 implements a mechanism for finding pre-existing programs applicable to posed problems, by searching the program store 160 and leveraging the domain knowledge in the knowledge store 150. The program creator module 165 implements a mechanism for creating new programs when no applicable pre-existing ones are found in the program store 160. The program creator module 165 leverages the domain knowledge in the knowledge store 150 to create more effective and domain-appropriate programs. The execution engine 130 among various other tasks, determines whether to use symbolic pattern match or neural network based match and proceeds with the right execution. The execution engine executes a program finalized for solving the current problem. The facts and the rules are applied during the execution step. While executing the program, the system retrieves relevant facts (or knowledge or information) or rules that need to be applied to execute a particular step of the program. Accordingly, the knowledge captured is applied in the execution process.

In one or more embodiments, the machine learning based language model 140 is a large language model (LLM) trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the DANA system 100 or one or more entities different from the DANA system 100. An LLM may be trained on a large amount of data from various data sources. For example, the data sources include websites, articles, posts on the web, and the like. From this massive amount of data coupled with the computing power of LLMs, the LLM is able to perform various tasks and synthesize and formulate output responses based on information extracted from the training data.

In one or more embodiments, the machine learning based language model 140 is a transformer neural network architecture. Specifically, the transformer model is coupled to receive sequential data tokenized into a sequence of input tokens and generates a sequence of output tokens depending on the task to be performed. In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the machine learning based language model 240 can be configured as any other appropriate architecture including, but not limited to, long short-term memory (LSTM) networks, Markov networks, BART, generative-adversarial networks (GAN), diffusion models (e.g., Diffusion-LM), and the like.

The training module 145 trains machine learning models used by the online system 200. The online system 200 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

In one or more embodiments, the DANA system 100 receives a pre-trained machine learning based language model 240 and the training module 145 additionally fine-tunes parameters of the machine learning based language model 140 using multiple instances of training data. An instance in the training data may include strings or sentences obtained by concatenating inputs and expected outputs of the machine learning based language model. For example, the training data may comprise natural language questions received from users with lists of items, item types, or categories of items associated with the natural language question. The machine learning based language model receives an input sentence with missing tokens from the output portion of the input sentence and predicts the missing tokens. A loss function is computed by aggregating loss values obtained from the predicted tokens and the known tokens of the output portion of the sentences provided as training data. The errors obtained from the loss function are backpropagated to update parameters of the machine-learned model.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The training module 145 generates the set of parameters for a machine learning model by “training” the machine learning model. Once trained, the machine learning model uses the set of parameters to transform inputs into outputs.

The training module 145 trains a machine learning model based on a set of training examples. Each training example includes input data to which the machine learning model is applied to generate an output. For example, each training example may include user data, item data, or order data. In some cases, the training examples also include a label which represents an expected output of the machine learning model. In these cases, the machine learning model is trained by comparing its output from input data of a training example to the label for the training example.

The training module 145 may apply an iterative process to train a machine learning model whereby the training module 145 trains the machine learning model on each of the set of training examples. To train a machine learning model based on a training example, the training module 145 applies the machine learning model to the input data in the training example to generate an output. The training module 215 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The training module 145 updates the set of parameters for the machine learning model based on the score generated by the loss function. For example, the training module 145 may apply gradient descent to update the set of parameters.

The machine-learned models may already be trained by a separate entity from the entity responsible for the DANA system 100. The training module 145 may further train parameters of the machine-learned model based on domain specific data obtained by the DANA system 100. As an example, the training module 145 may obtain a pre-trained transformer language model and further fine tune the parameters of the transformer model using training data obtained by the DANA system 100.

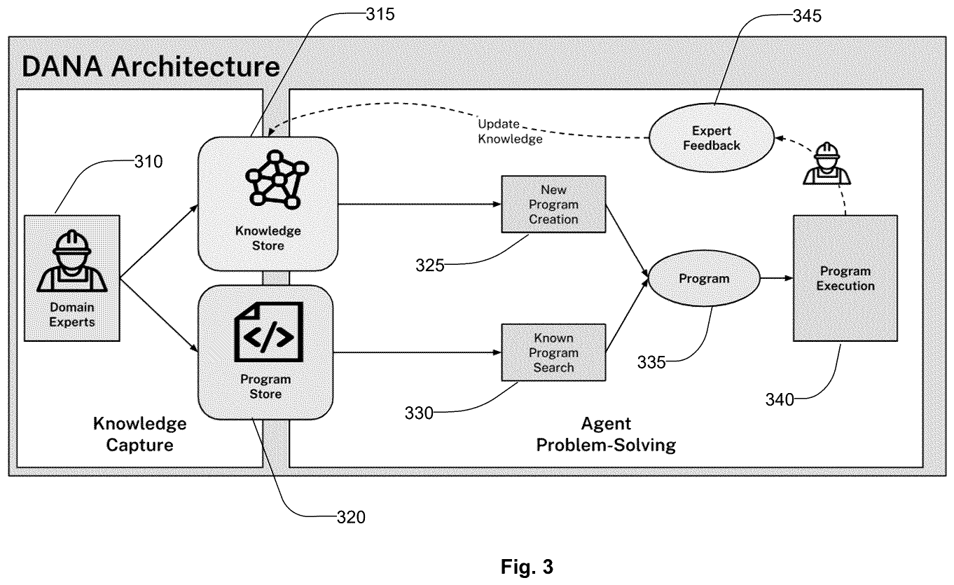

FIG. 3 illustrates various components of the DANA architecture and their interactions, according to an embodiment. The DANA system 100 receives domain specific knowledge from domain experts 310. The knowledge capture process may be manual or automatic. The information obtained from domain experts is stored in knowledge store 315 and program store 320. For example, the knowledge store 315 stores domain specific facts and program store stores domain specific programs representing instructions to perform domain specific tasks. An agent, for example, a DANA agent receives description of a new domain specific task to perform. The agent determines whether the task should be solved using non-deterministic neural computing, for example, using a trained machine learning based model or by deterministic symbolic processing, for example, a program. If the agent determines that the task should be solved using symbolic processing, the agent performs known program search 330 for programs stored in the program store 320 to determine if any existing program can be used for solving the domain specific task. If the agent determines that none of the existing programs stored in the program store 320 are able to solve the domain specific task, the agent generates a new program 325 for solving the task. The agent may generate a new program for solving the task using the machine learning based language model by using the domain specific knowledge stored in the knowledge store 315.

### Automatic Knowledge Capture

The DANA system 100 receives domain specific knowledge from domain experts 310. The DANA system 100 system determines whether some information received from an expert is (1) fact, (2) rule or (3) program. The system stores the three different types of information in different formats and processes them differently. The DANA system 100 may perform manual capture by receiving information provided by domain experts, for example, by uploading documents, manually entering information, and so on. The DANA system 100 may perform automatic capture by interactively asking questions to the domain expert via a user interface and receiving answers and storing information extracted from the answers.

According to an embodiment, an agent performs the following steps repeatedly. The agent generates a domain specific question for the particular domain. The agent may generate a domain specific question using a machine learning based language model. Accordingly, the agent generates a structured query input requesting the machine learning based language model to generate a set of seed questions for the particular domain. A structured query input may also be referred to herein as a prompt. The agent sends the structured query input to the machine learning based language model and receives a response generated by executing the machine learning based language model. The agent extracts the questions from the response. The agent may generate a structured query input for a specific question and request the machine learning based language model to generate additional questions related to the specified questions. The agent may generate structured query input that includes a specific question and one or more answers provided by the expert user with a request to generate additional questions related to the specified question in view of the answers provided by the user so far and provides the structured query input for processing to the machine learning based language model. The agent sends the domain specific question for display via a user interface and receives an answer to the domain specific question via the user interface. The agent stores the information obtained from the answer provided by the user.

The agent determines whether the information received from the expert represents a fact, rule or program and stores the information appropriately. For example, if the agent determines that the information received is a fact, the agent stores the fact with appropriate metadata. If the agent determines that the information received is a rule, the agent stores the rule with appropriate conditional structure and other relevant metadata. If the agent determines that the information received is a program, the agent stores appropriate metadata of program along with distinct steps of or code for that program.

According to an embodiment, the agent uses a machine learning based model, for example, a classifier to determine whether the information received from the expert represents a fact, rule or program. The agent uses a machine learning based model that trained to receive as input a representation of any information, for example, information received from a domain expert user. The representation of the information may be in text format as a string or as an embedding generated by a machine learning based language model. The agent provides the representation of the input to the classifier to predict a score indicating whether the input is fact, rule or program.

According to an embodiment, the DANA system 100 receives a pre-trained machine learning based language model and fine tunes the machine learning based language model for more accurate classification of information as fact, rule, or program. For example, the system obtains a set of examples of facts, rules, and programs and tags them with their classification. The system further trains the pretrained machine learning based language model using additional data to improve the accuracy of the model.

According to an embodiment, the system generates a prompt with examples of facts, rules, and programs and provides the examples along with a new information received from the user as input to the machine learning based language model. The prompt requests the machine learning based language model to user the examples as help for classifying certain information. The machine learning based language model uses the examples to better classify the information.

The system may store different types of information using different representations. The system may store a fact using a generic representation as a known quality or quantity related to a topic or entity of interest in a certain domain. The system may use formats that capture a wide variety of facts that are possible, for example, by representing facts as natural-language statements. The system may store facts as structured symbolic forms such as logic relations. The system may store metadata with a fact, for example, the topic or entity of interest and the name of the quality or quantity being measured or evaluated.

The system may store rules using an if-then statement, for example, “IF <condition> THEN <a fact is (un)likely to be true>.” The system may store rules as natural-language statements or as logic relations. To capture a rule, the system may pose scenarios in the domain in which a certain operating condition holds true, and asks the expert, given that operating condition, which other conditions are highly likely or unlikely.

The system stores programs using a representation that comprises metadata along with description of steps of a process. The metadata of the process may include description of the purpose(s) or problem statement(s) for which the program can be used. The representation of the program may comprise a sequence of steps, each step specified as natural language text, or a programming-code function or script. The program may be represented using natural-language instructions. According to an embodiment, the system uses a program representation that comprises a hierarchical tree structure representing how a problem/task may be decomposed into simpler/smaller tasks, and the sequence of resolving those simpler/smaller tasks to resolve the overall problem/task. The system may represent a program as a programming-language function or script.

According to an embodiment, if the system determines that the information being provided by the expert user represents a program, the system presents a series of questions that identify distinct steps of the program. The agent may present to the expert user, problem-solving scenarios from the domain and record and restructure how the expert user solves such scenarios. The system recognizes and stores the key steps and sub-steps described by the user. The agent may dynamically generate questions that clarify with the interviewed expert, how complex tasks can be decomposed into simpler/smaller tasks that may be performed more easily. According to an embodiment, the agent creates proposed programming code representing the expert's recommended solution and asks the expert user for verification of such code. For example, the agent may generate a prompt requesting a machine learning based language model to generate instructions using a particular programming language that encode the steps specified by the expert user. The agent sends the prompt to the machine learning based language model and extracts the program from the response generated by the machine learning based language model.

### Apply Knowledge

The DANA system 100 stores a library of facts, rules and programs and applies them in various contexts. The system determines which existing program to apply in a given context. If none of the existing programs apply to the current context the system determines that a new program needs to be created. The system utilizes relevant facts and rules to execute such a program consistently and accurately.

According to an embodiment the system stores a set of programs in a library. The system generates a signature of the program that includes (1) metadata/description of the program (or type of program) (2) Inputs required by the program, and (3) Output generated by the program.

The system receives information describing a new task to be executed and a context in which the task is being executed. The information may represent sensor data, a question provided by a user, a step in an industrial process, and so on. The system attempts to determine which program stored in the library is applicable in a given context. If a program matches, the system executes the program with relevant facts and rules where applicable. If none of the available programs match, the system creates a new program and executes it with relevant facts and rules where applicable.

According to an embodiment, the system determines which program to apply in a given context by comparing the description of the received task along with context of the received task with the metadata describing the available programs. According to an embodiment, the system stores metadata describing each available program in a vector database. Accordingly, the system provides a description of the program as input to a machine learning based language model and generates a vector representation of the metadata. The system stores the vector representations of the description of each available program in a vector database. The system generates a vector representation based on the received task and determines a matching program based on vector distances between the vector representation of the received task and vector descriptions of the available programs. The system may select the program with the closest vector distance or the highest similarity based on a similarity metric, for example, cosine similarity.

The system determines whether the program that is the best match can be executed in the given context for the received task. The system determines whether the description of the task and the context has sufficient information to populate each input parameter of the program. A program may have certain required inputs and certain optional inputs. In this case, the system determines whether the description of the task and the context has sufficient information to populate each required input parameter of the program. The system may match input data to each parameter of the program. The system may use a machine learning based language program to determine whether the description of the task and the context has information to determine values of the input parameters of the program. The system generates a prompt including the description of the program and the description of the task and the context and request the machine learning based language program to determine whether the description of the task and the context has information to determine values of each of the required input parameters of the program. The system may use the prompt to extract the values for each required input parameter of the program from the description of the task and the context. If the system is able to determine values for each of the required input parameters of the program from the description of the task and the context, the system executes the program to complete the received task.

If none of the existing programs match, the system uses the machine learning based language model to generate a new program. The system adds the new program to the library (or repository) of the programs. This allows the system to grow the library of domain specific programs for the particular domain.

According to an embodiment, the system generates a new program by performing the following steps. The system generates a prompt for the machine learning based language model describing the received task and the current context. The prompt may include following information: (1) Description of the problem from the context. (2) Format of the program to be created, e.g., hierarchical task plan, Python program, etc. (3) relevant facts and rules that have already been captured. (4) Description of existing programs that were determined to be the closest to the received task and context along with reasons why the match failed. For example, the system may include in the prompt, information indicating that a particular program P1 was the best match but failed to match because P1 requires 4 parameters and the context only has information for two parameters. (5) Request to generate a program based on specified parameters. The system sends the prompt to the machine learning based language model and receives the response generated by executing the machine learning based language model. The system stores the generated program along with metadata describing the program.

According to an embodiment, the system sends the generated program to an expert user to verify that the generated program is able to perform the received domain specific task or solve the received domain specific problem. The generation of the process may trigger the knowledge capture phase.

### Execution Engine

The DANA system 100 identifies a program that matches a given context we need to match the context with the program description and the parameters. The match of different types of information may be performed using (1) symbolic match and (2) neural network based probabilistic match. The system makes a decision, whether to perform a symbolic match or a neural network match in a given context.

The system stores a set of programs in a library, each program description representing a signature of the program and including the program description and input parameters. The system performs a match of the description of the task and input context with the process information comprising the program description and the input parameters. The system determines whether to perform symbolic match or neural network based probabilistic match of the information including one (1) the description of the input task and context and the (2) the program description. If the system determines that the information is structured and concrete, for example, using a syntax of a programming language, the system performs symbolic pattern match. If the system determines that the information is unstructured, for example, using natural language, the system performs neural network-based pattern match. The system applies the selected matching technique based on the determination, for example, by applying one of the symbolic match or the neural network based probabilistic match. The system executes the matching program.

The system further determines how to execute the program. According to an embodiment, the system quantifies whether program instructions are concrete and structured or unstructured. The system may determine a metric (or a score) indicating a degree of structured/unstructured nature of the program instructions. The system compares the score against a threshold to determine whether to perform symbolic execution of the program or a neural network based probabilistic execution of the program. If the system determines that the program is natural-language or largely natural-language-based, the score indicates that the information is unstructured, and the system performs the execution through a reasoning mechanism conducted by a machine learning based language model. If the system determines that the program is symbolic and structured, for example, using a syntax of a programming-language, the system executes the program using an appropriate symbolic processing engine, for example, an interpreter of the programming language used to specify the program.

The DANA system 100 was used for semiconductor domain to build an etching advisor. An AI agent constructed with the DANA system 100, was given access to an etching expert knowledge and program Stores. Furthermore, the etching advisor employed a machine learning based language model that was fine tuned by further training using semiconductor industry-specific information, to further enhance the precision and relevance of its analyses and recommendations. This DANA-based etching advisor was capable of providing highly plausible etching recipes, including pros-and-cons comparisons among feasible alternatives, thus helping process engineers save significant analysis time and arrive at their final etching recipes more quickly. The semiconductor domain is mentioned as an example domain and the techniques disclosed can be applied to various other domains.

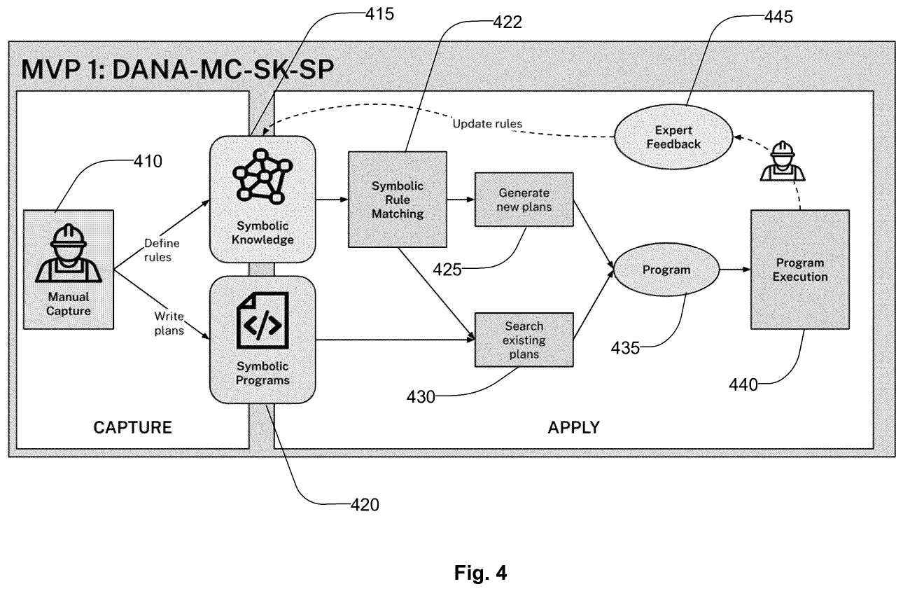

FIG. 4 illustrates various components of the DANA architecture and their interactions, according to an embodiment. The system performs manual capture 410 of information from one or more experts. The system obtains symbolic knowledge 415 and symbolic programs 420. The system performs symbolic rule matching 422 to search existing plans 430 or generate new plans 425. The system executes 440 the program 435 that was either generated or retrieved from program store. The program 435 or the results of execution of the program 435 may be provided to an expert for feedback 445 to update the facts, for example, symbolic knowledge 415 or the symbolic programs 420.

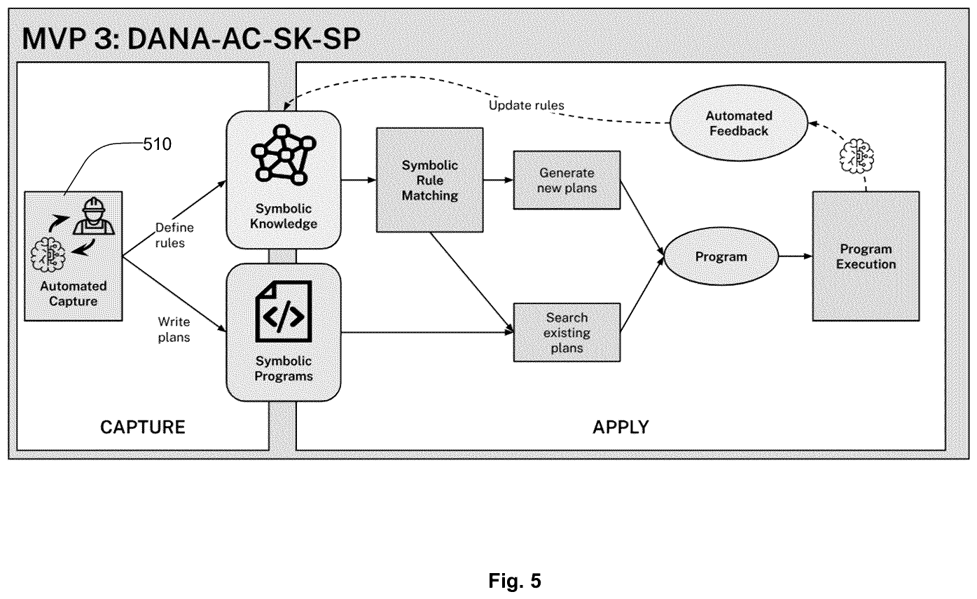

FIG. 5 illustrates various components of the DANA architecture and their interactions, according to an embodiment. The system disclosed in FIG. 5 is similar to the system disclosed in FIG. 4, except for the fact that the system disclosed in FIG. 5 performs automated capture 510.

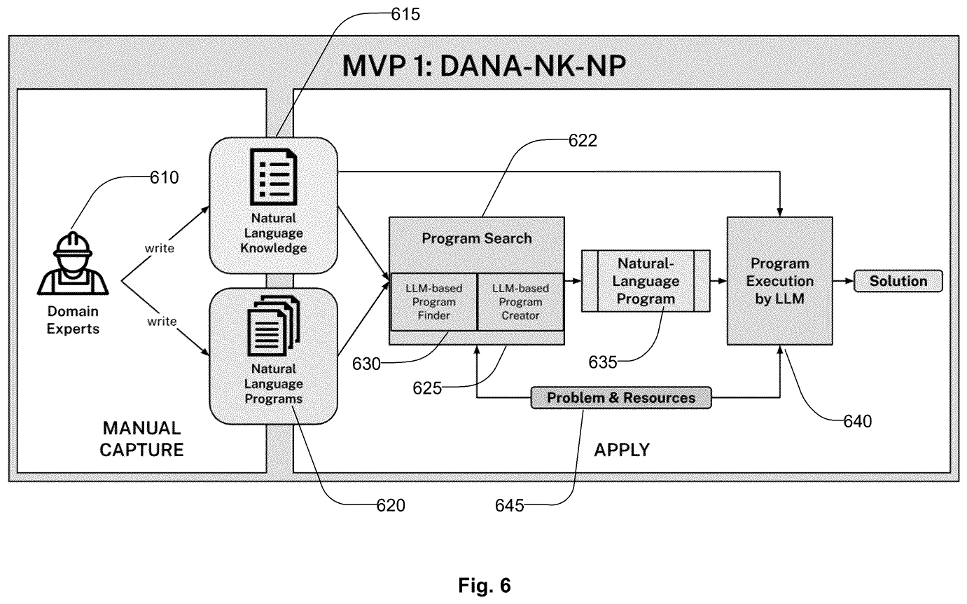

FIG. 6 illustrates various components of the DANA architecture and their interactions, according to an embodiment. The system performs manual capture based on information provided by domain expert 610. The system stores knowledge 615 represented as natural language and programs 620 also represented as natural language. The system performs program search 622 to find existing programs using the LLM-based program finder 630 and creates a new program using the LLM-based program creator 625 if no existing program is found. The system executes 640 the natural language program 635 that was existing or created using a machine learning based language model, e.g., LLM to determine a solution. The program execution 640 uses known problems and resources, for example, as examples.

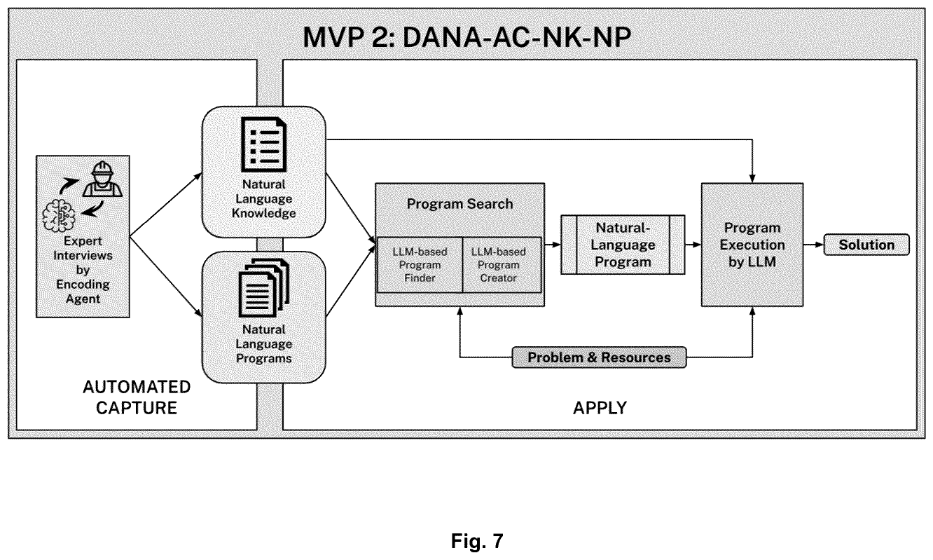

FIG. 7 illustrates various components of the DANA architecture and their interactions, according to an embodiment. The system shown in FIG. 7 performs similar to the system disclosed in FIG. 6 except for using an automated capture using agent generated interviews of the expert user.

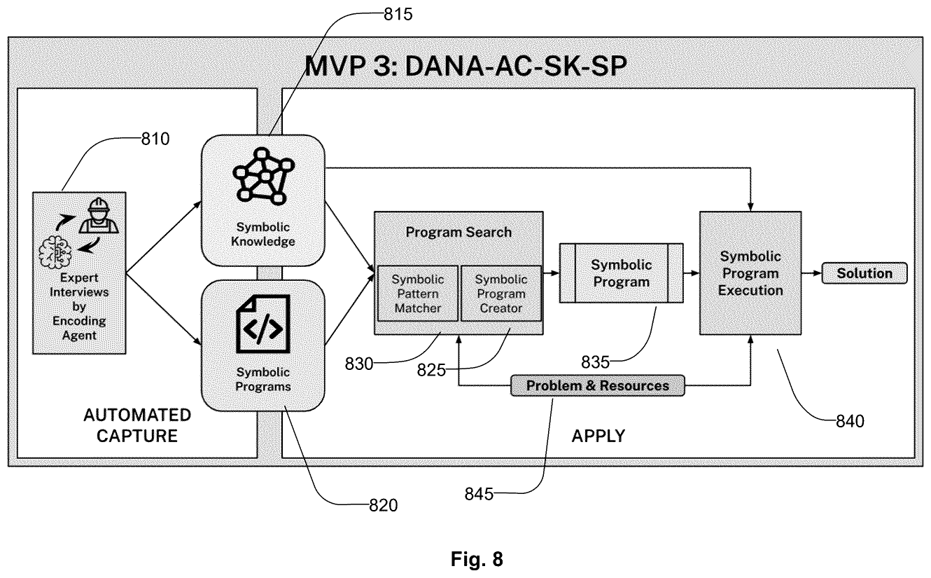

FIG. 8 illustrates various components of the DANA architecture and their interactions, according to an embodiment. The system performs automated capture 810 from domain experts using expert interviews that are generated by agents. The system stores symbolic knowledge 815 and symbolic programs 820 also represented as natural language. The system performs program search 822 to find existing programs using the symbolic pattern matcher 830 and creates a new program using the symbolic program creator 825 if no existing program is found. The system executes 840 the symbolic program 835 that was existing or created using symbolic program execution to determine a solution. The program execution 840 uses known problems and resources, for example, as examples.

### Technical Improvements

Machine learning based language models such as Large Language Models (LLMs) allow generation of various types of responses based on natural language inputs. However, machine learning based language models have an inherent probabilistic nature that results in non-deterministic outputs being generated by such models. For example, such models may perform random sampling, that may result in variations across executions of the model for the same input. Accordingly, if the machine learning based language models is executed multiple times for the same input data, the machine learning based language models may generate different outputs during each execution. This leads to inconsistency and inaccuracy in problem-solving tasks based on use of machine learning based language models. As a result non-deterministic output is a technical problem caused by use of probabilistic machine learning based language models. The system disclosed according to various embodiments, for example, DANA (Domain-Aware Neurosymbolic Agent) provides a technical solution to this technical problem. The system disclosed addresses these challenges by integrating domain-specific knowledge with neurosymbolic approaches. The system incorporates domain expertise in both natural-language and symbolic forms, enabling a deterministic and reliable problem-solving characteristics. For example, the system was tested to determine that it achieves over 90% accuracy on a benchmark, significantly outperforming current LLM-based systems in both consistency and accuracy. The system provides a technical improvement in the field of machine learning, in particular neurosymbolic AI by utilizing a flexible architecture that leverages domain knowledge to mitigate the probabilistic limitations of LLMs. The system uses domain-aware neurosymbolic agents that allow use of machine learning based language models for processing complex, real-world problems that require precision and reliability, allowing solution of practical applications in AI system design where consistency and accuracy are significant.

Existing prior art systems that attempt to address the non-deterministic behavior of such machine learning based language models are usually resource- and time-intensive and may get stuck in loops. As a result, such systems utilize extensive computation and communication resources due to significant invocations of APIs. The performance of such systems may be unpredictable due to varying task complexity. The system according to various embodiments as disclosed improves utilization of computing and communication resources and thereby improves computational efficiency compared to existing systems while providing predictable performance.

The DANA system 100 achieves superior performance in complex problem-solving tasks compared to existing techniques. The system achieves:
(1) Enhanced Precision: by incorporating domain expertise, the DANA system 100 achieves higher levels of accuracy and consistency, crucial for applications in fields such as manufacturing and healthcare, where such qualities are greatly important.
(2) Reduced Errors: the integration of expert knowledge in DANA system 100 helps mitigate the risk of costly errors that can occur with conventional techniques, especially in high-stakes industrial environments.
(3) Improved Interpretability: the DANA system 100 uses domain-specific knowledge representation to make decision-making process more transparent and interpretable, addressing a key concern in industrial adoption of AI.
(4) Faster Deployment: the DANA system 100 leverages existing domain expertise to accelerate the deployment of AI systems in new industrial contexts, reducing the need for extensive data collection and model training. Accordingly, the system provides improved utilization of computational and networking resources compared to existing techniques by requiring less model training and reducing the amount of training data that needs to be stored.

### Computer Architecture

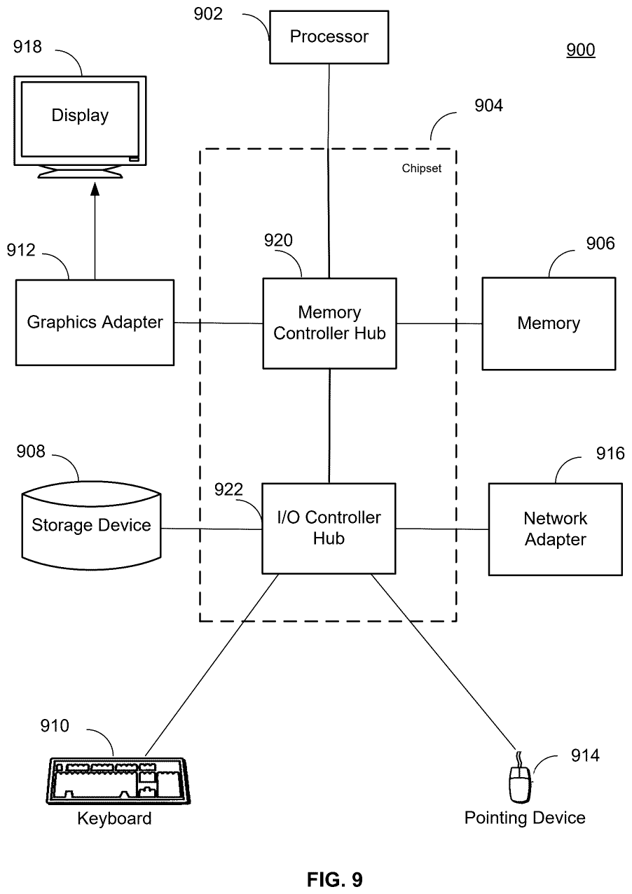

FIG. 9 is a high-level block diagram illustrating an example system, in accordance with an embodiment. The computer 900 includes at least one processor 902 coupled to a chipset 904. The chipset 904 includes a memory controller hub 920 and an input/output (I/O) controller hub 922. A memory 906 and a graphics adapter 912 are coupled to the memory controller hub 920, and a display 918 is coupled to the graphics adapter 912. A storage device 908, keyboard 910, pointing device 914, and network adapter 916 are coupled to the I/O controller hub 922. Other embodiments of the computer 900 have different architectures.

The storage device 908 is a non-transitory computer-readable storage medium such as a hard drive, compact disk read-only memory (CD-ROM), DVD, or a solid-state memory device. The memory 906 holds instructions and data used by the processor 902. The pointing device 914 is a mouse, track ball, or other type of pointing device, and is used in combination with the keyboard 910 to input data into the computer system 900. The graphics adapter 912 displays images and other information on the display 918. The network adapter 916 couples the computer system 900 to one or more computer networks.

The computer 900 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 908, loaded into the memory 906, and executed by the processor 902. The types of computers 900 used can vary depending upon the embodiment and requirements. For example, a computer may lack displays, keyboards, and/or other devices shown in FIG. 9.

### Additional Considerations

It is to be understood that the Figures and descriptions of the present invention have been simplified to illustrate elements that are relevant for a clear understanding of the present invention, while eliminating, for the purpose of clarity, many other elements found in a typical distributed system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for displaying charts using a distortion region through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method comprising:
storing domain specific information obtained from one or more users, the domain specific information for a particular domain and comprising (1) a set of domain specific facts and (2) a set of domain specific programs;
receiving an input request to perform a domain specific task for the particular domain;
providing the input request to a machine learning model trained to predict a score indicating whether the input request should be processed by a symbolic processor or by a neural network, wherein the symbolic processor generates deterministic output and the neural network generates a non-deterministic output;
executing the machine learning model to predict a score indicating whether the input request should be processed by a symbolic processor or by a neural network;
responsive to the score predicted by the machine learning model indicating that the input request should be processed by the symbolic processor, determining whether a domain specific program from the set of domain specific programs is configured to solve the input request; and
responsive to determining that none of the set of domain specific programs are configured to solve the input request generating a new program for solving the input request using a machine learning based language model and the set of domain specific facts.

2. The computer-implemented method of claim 1, further comprising, repeatedly performing:
generating a domain specific question for the particular domain;
sending the domain specific question for display via a user interface;
receiving an answer to the domain specific question via the user interface; and
storing information obtained from the answer.

3. The computer-implemented method of claim 1, further comprising, repeatedly performing:
generating a search query associated with the particular domain;
sending the search query to a search engine;
receiving a set of search results from the search engine; and
storing one or more search results.

4. The computer-implemented method of claim 1, wherein determining whether a domain specific program from the set of domain specific programs is configured to solve the input request comprises, for one or more domain specific programs from the set of domain specific programs:
selecting a domain specific program from the set of domain specific programs;
determining a set of required inputs of the domain specific program;
determining whether the input request comprises information to determine values corresponding to each of the set of required inputs of the domain specific program; and
responsive to determining that the input request specifies values corresponding to each of the set of required inputs of the domain specific program, determining that the domain specific program is configured to solve the input request.

5. The computer-implemented method of claim 1, wherein the particular domain comprises knowledge of semiconductor processes.

6. The computer-implemented method of claim 1, wherein responsive to the score predicted by the machine learning model indicating that the input request should be processed by a neural network:
generating a structured query for a machine learning based language model, the structured query describing the input request;
sending the structured query to the machine learning based language model; and
receiving a response generated by the machine learning based language model.

7. The computer-implemented method of claim 1, wherein generating a new domain specific program comprises:
determining a set of inputs and outputs of a potential domain specific program for processing the input request;
generating a structured query for a machine learning based language model, the structured query describing the input request and the set of inputs and outputs;
sending the structured query to the machine learning based language model; and
receiving a response generated by the machine learning based language model, the response comprising instructions for the new domain specific program.

8. A non-transitory computer readable storage medium storing instructions that when executed by one or more computer processors, cause the one or more computer processors to perform steps comprising:
storing domain specific information obtained from one or more users, the domain specific information for a particular domain and comprising (1) a set of domain specific facts and (2) a set of domain specific programs;
receiving an input request to perform a domain specific task for the particular domain;
providing the input request to a machine learning model trained to predict a score indicating whether the input request should be processed by a symbolic processor or by a neural network, wherein the symbolic processor generates deterministic output and the neural network generates a non-deterministic output;
executing the machine learning model to predict a score indicating whether the input request should be processed by a symbolic processor or by a neural network;
responsive to the score predicted by the machine learning model indicating that the input request should be processed by the symbolic processor,
determining whether a domain specific program from the set of domain specific programs is configured to solve the input request; and
responsive to determining that none of the set of domain specific programs are configured to solve the input request generating a new program for solving the input request using a machine learning based language model and the set of domain specific facts.

9. The non-transitory computer readable storage medium of claim 8, wherein the instructions further cause the one or more computer processors to perform steps comprising, repeatedly performing:
generating a domain specific question for the particular domain;
sending the domain specific question for display via a user interface;
receiving an answer to the domain specific question via the user interface; and
storing information obtained from the answer.

10. The non-transitory computer readable storage medium of claim 8, wherein the instructions further cause the one or more computer processors to perform steps comprising, repeatedly performing:
generating a search query associated with the particular domain;
sending the search query to a search engine;
receiving a set of search results from the search engine; and
storing one or more search results.

11. The non-transitory computer readable storage medium of claim 8, wherein instructions for determining whether a domain specific program from the set of domain specific programs is configured to solve the input request further cause the one or more computer processors to perform steps comprising, for one or more domain specific programs from the set of domain specific programs:
selecting a domain specific program from the set of domain specific programs;
determining a set of required inputs of the domain specific program;
determining whether the input request comprises information to determine values corresponding to each of the set of required inputs of the domain specific program; and
responsive to determining that the input request specifies values corresponding to each of the set of required inputs of the domain specific program, determining that the domain specific program is configured to solve the input request.

12. The non-transitory computer readable storage medium of claim 8, wherein the particular domain comprises knowledge of semiconductor processes.

13. The non-transitory computer readable storage medium of claim 8, wherein instructions further cause the one or more computer processors to perform steps comprising, responsive to the score predicted by the machine learning model indicating that the input request should be processed by a neural network:
generating a structured query for a machine learning based language model, the structured query describing the input request;
sending the structured query to the machine learning based language model; and
receiving a response generated by the machine learning based language model.

14. The non-transitory computer readable storage medium of claim 8, wherein instructions for generating a new domain specific program cause the one or more computer processors to perform steps comprising:
determining a set of inputs and outputs of a potential domain specific program for processing the input request;
generating a structured query for a machine learning based language model, the structured query describing the input request and the set of inputs and outputs;
sending the structured query to the machine learning based language model; and
receiving a response generated by the machine learning based language model, the response comprising instructions for the new domain specific program.

15. A computer system comprising:
one or more computer processors; and
a non-transitory computer readable storage medium storing instructions that when executed by the one or more computer processors, cause the one or more computer processors to perform steps comprising:
storing domain specific information obtained from one or more users, the domain specific information for a particular domain and comprising (1) a set of domain specific facts and (2) a set of domain specific programs;
receiving an input request to perform a domain specific task for the particular domain;
providing the input request to a machine learning model trained to predict a score indicating whether the input request should be processed by a symbolic processor or by a neural network, wherein the symbolic processor generates deterministic output and the neural network generates a non-deterministic output;
executing the machine learning model to predict a score indicating whether the input request should be processed by a symbolic processor or by a neural network;
responsive to the score predicted by the machine learning model indicating that the input request should be processed by the symbolic processor,
determining whether a domain specific program from the set of domain specific programs is configured to solve the input request; and
responsive to determining that none of the set of domain specific programs are configured to solve the input request generating a new program for solving the input request using a machine learning based language model and the set of domain specific facts.

16. The computer system of claim 15, wherein the instructions further cause the one or more computer processors to perform steps comprising, repeatedly performing:
generating a domain specific question for the particular domain;
sending the domain specific question for display via a user interface;
receiving an answer to the domain specific question via the user interface; and
storing information obtained from the answer.

17. The computer system of claim 15, wherein the instructions further cause the one or more computer processors to perform steps comprising, repeatedly performing:
generating a search query associated with the particular domain;
sending the search query to a search engine;
receiving a set of search results from the search engine; and
storing one or more search results.

18. The computer system of claim 15, wherein instructions for determining whether a domain specific program from the set of domain specific programs is configured to solve the input request further cause the one or more computer processors to perform steps comprising, for one or more domain specific programs from the set of domain specific programs:
selecting a domain specific program from the set of domain specific programs;
determining a set of required inputs of the domain specific program;
determining whether the input request comprises information to determine values corresponding to each of the set of required inputs of the domain specific program; and
responsive to determining that the input request specifies values corresponding to each of the set of required inputs of the domain specific program, determining that the domain specific program is configured to solve the input request.

19. The computer system of claim 15, wherein the instructions further cause the one or more computer processors to perform steps comprising, responsive to the score predicted by the machine learning model indicating that the input request should be processed by a neural network:
generating a structured query for a machine learning based language model, the structured query describing the input request;
sending the structured query to the machine learning based language model; and
receiving a response generated by the machine learning based language model.

20. The computer system of claim 15, wherein instructions for generating a new domain specific program cause the one or more computer processors to perform steps comprising:
determining a set of inputs and outputs of a potential domain specific program for processing the input request;
generating a structured query for a machine learning based language model, the structured query describing the input request and the set of inputs and outputs;
sending the structured query to the machine learning based language model; and
receiving a response generated by the machine learning based language model, the response comprising instructions for the new domain specific program.
